(19) United States
(12) Patent Application Publication
(10) Pub. No.: US 2020/0155272 A1
(43) Pub. Date: May 21, 2020

(54) DENTAL CARVING INSTRUMENTS WITH DETACHABLE BLADE AND RELATED METHODS

(71) Applicant: The University of North Carolina at Chapel Hill, Chapel Hill, NC (US)

(72) Inventor: Glenn Edward Garland, Chapel Hill (US)

(21) Appl. No.: 16/690,809

(22) Filed: Nov. 21, 2019

Related U.S. Application Data
(63) Continuation of application No. PCT/US2018/033903, filed on May 22, 2018.
(60) Provisional application No. 62/509,367, filed on May 22, 2017.

(51) Int. Cl. A61C 3/02; A61C 1/12

(52) U.S. Cl. CPC A61C 3/02; A61C 1/12

(57) ABSTRACT

Dental carving tools and methods utilizing a detachable blade are provided. An example dental carving tool includes at least a working portion with a detachable blade disposed at an angle offset from the longitudinal handle axis. The blade can include a planar portion and an additional either curved or flat surface, with the surface curving inwardly or outwardly from the orientation of the dental practitioner. The cutting edge can be curving or flat, with one or both edges sharpened.

### CROSS-REFERENCE TO RELATED APPLICATIONS

This application is a continuation of and claims priority to PCT/US2018/033903 filed May 22, 2018, which claims the benefit of and priority to U.S. Provisional Patent Application Ser. No. 62/509,367, filed on May 22, 2017, the disclosures of which are incorporated herein by reference in their entirety.

### TECHNICAL FIELD

The disclosure herein relates generally to the field of dental restoration tools. More particularly, the disclosure herein related to dental carving instruments with a detachable blade and related methods.

### BACKGROUND

There are many types of hand-held instruments designed for use with dental restorations for human teeth. However, many of these instruments are designed to be used in conjunction with amalgam restorations. Amalgam restorations go through a soft stage of curing, wherein they are easily sculpted using tools with various degrees of sharpness. Newer composite restorations, on the other hand, cure quickly and have a high hardness during the finishing process. Finishing tools must have a sharp working edge and a high strength. The working edges can be easily worn down and difficult to sharpen. Furthermore, the geometry of many existing tools is not advantageous for all regions of the mouth. It is particularly difficult to use existing sculpting or carving tools to finish dental composite restorations in posterior teeth.

### SUMMARY

The disclosure herein relates to tools and methods for use in treatment of teeth for dental restoration, specifically a carving tool for finishing the surface of a composite filling on posterior teeth. Many tools in use today have maintained essentially the same geometry for decades, while the science of tooth restoration has undergone many changes. The composite restorations used in modern fillings have very different properties from the amalgam fillings common in past decades; however, the tools used to sculpt and finish the restorations have not changed with the materials.

With older amalgam fillings, the finishing process passed through a putty state, where the material was easy to carve and sculpt. Composite fillings are much harder and bond more strongly to teeth, making it necessary to apply more force during the restoration process and to use sharper instruments. Additionally, many blade-edge tools available today do not have a geometry that is conducive to easily reach all of the surfaces of posterior teeth. Thus, there is a need for a dental restoration carving tool configured to maintain sharpness while effectively accessing posterior teeth. The disclosure presented herein provides a solution to this problem.

By providing a dental carving tool with the blade at an angle relative to the grip, it is easier to access difficult-to-reach areas of the mouth such as the molars. The angled geometry also provides a mechanical advantage for applying a higher pressure on a tooth while maintaining the tool in a position that is easily controlled by the dental provider. This allows more efficient restoration and other types of dental treatment, particularly on posterior teeth. A carving tool as disclosed herein can be used to scrape, sculpt, cut, carve, etc. amalgam, composite, or other tooth restorations, as well as performing treatments on natural teeth. Another advantageous feature of the sculpting tool is use of a detachable or removable blade. Tool sharpening can be difficult and costly. Providing the blade as a replaceable element extends the life of the tool and makes sterilization easier by limiting the process to the grip portion. Additionally, the grip portion can be reused, and the working portion can always be as sharp as possible.

In one aspect, a dental carving tool can have an elongated grip portion, a working portion, and a detachable blade, where the working portion has a distal section offset at an angle from the longitudinal axis of the grip and has a mounting element for the detachable blade.

In another aspect, the dental carving tool can be provided as a system comprising a plurality of blades.

### BRIEF DESCRIPTION OF THE DRAWINGS

A full and enabling disclosure of the present subject matter is set forth more particularly in the remainder of the specification, including reference to the accompanying figures, relating to one or more embodiments, in which:

FIG. 1 is an isometric view of a dental carving tool according to the disclosure herein;

FIG. 2 is a partial elevation view of a dental carving tool according to the disclosure herein;

FIG. 3A-3C are various views of an embodiment of a detachable blade according to the disclosure herein;

FIG. 4A is a partial view of an embodiment of a dental carving tool according to the disclosure herein;

FIGS. 4B-4D are example usage views of an embodiment of a dental carving tool according to the disclosure herein;

FIG. 5A-5C are various views of an embodiment of a detachable blade according to the disclosure herein; and

FIGS. 6-8 are various views of embodiments of detachable blades according to the disclosure herein.

### DETAILED DESCRIPTION

The subject matter disclosed herein addresses problems encountered in a traditional method of applying a composite restoration to a posterior tooth. Existing tools are often limited by sharpness and/or geometry and are not designed for finishing composite restorations at the back of the mouth. Many conventional tools have either a small, easily dulled cutting region, or a larger blade that is parallel to the longitudinal axis of the gripping portion. In these cases it is challenging for the dental provider to reach difficult areas, such as, for example, the interproximal regions between molars. The disclosure herein overcomes this obstacle by providing a tool with a large detachable blade that is disposed an angle substantially offset from the longitudinal axis.

FIG. 1 illustrates an example embodiment of a dental carving tool, generally designated 100. Dental carving tool 100 can comprise an elongated grip portion 110, at least one or more working portion 120, and a detachable blade 130. Detachable blade 130 is attached to working portion 120 by a mounting feature 128. Grip portion 110 has a proximal end 112 and a distal end 114. Proximal end 112 is defined as the end of dental carving tool 100 closest to a user when held in a usage position, and distal end 114 is the end farthest from the user when held in a usage position. As shown in FIG. 1, dental carving tool 100 comprises one working portion 120 on distal gripping end 112. Dental carving tool 100 can in some aspects comprise two working portions 120 with two detachable blades 130. It is also envisioned that dental carving tool 100 can comprise one end that comprises a working portion 120 and detachable blade 130 while the opposing end comprises no working portion or a different working portion. Grip portion 110 can be suitably proportioned and configured according to conventional hand-held dental instrument dimensions. For example, grip portion 110 can, for example, be approximately 3 inches to 6 inches long and have a cross-sectional diameter of approximately ⅛ to ¾ inches. The longitudinal surfaces of grip portion 110 can, for example, comprise knurled or faceted sides. In the example embodiment of FIG. 1, grip portion 110 of dental carving tool 100 extends along a primary longitudinal axis X.

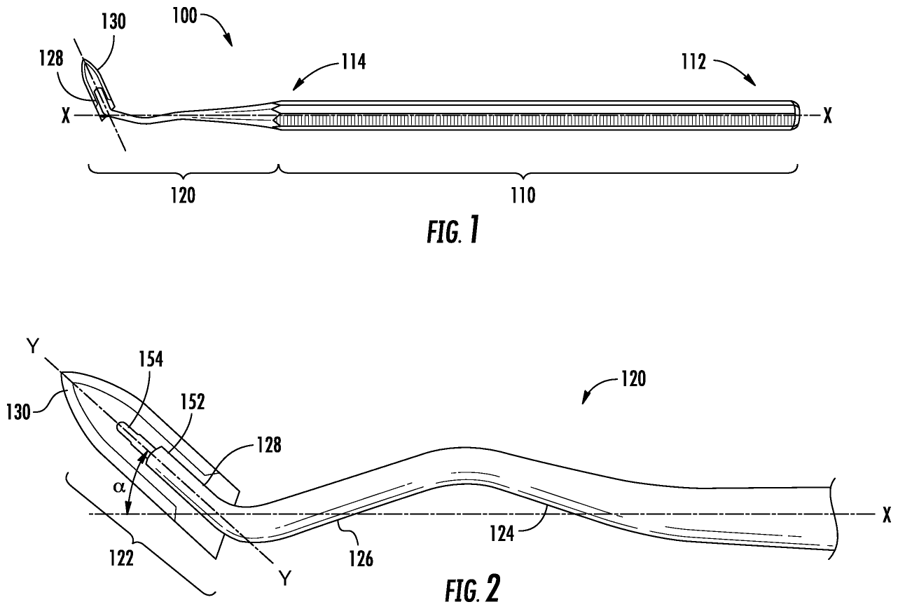

FIG. 2 is a closer view of one working portion 120. Working portion 120 is for being disposed on an end of grip portion 110 as described above, such as, for example, as an integral or attached extension of grip portion 110. Working portion 120 can comprise at least a distal section 122, which can have a longitudinal axis Y disposed at an angle α offset from the longitudinal axis. The angle a is preferably in the range of approximately (e.g., ±10%) 35°-90°. In a preferred embodiment, distal section 122 can be, for example, disposed at an angle of approximately or substantially 75° relative to the primary longitudinal axis X. This allows the dental practitioner (i.e., the tool user) to easily access the surfaces of posterior teeth, such as molars for example, while having good visibility of the area being worked on. Working portion 120 can be formed integrally with grip portion 110, or it can be attached in any manner that a person of ordinary skill in the art would readily appreciate.

In the example embodiment of a portion of dental carving tool 100 shown in FIG. 2, working portion 120 comprises optional first and second sections 124 and 126, respectively. First and second sections 124 and 126 are also disposed at an angle from longitudinal axis X. First section 124 can be at an angle, for example, in the range of approximately 2°-45° away from the longitudinal axis, and second section 126 can be at an angle, for example, in the range of approximately 2°-45° from first section 124 and toward the longitudinal axis. Second section 126 can be in the same plane as first section 124, or it can be offset from first section 124 and in a different plane. Similarly, distal section 122 can be disposed in the same plane as an adjacent section (e.g., 124, 126), or in a different plane. The example embodiment, however, should not be construed as limiting, as working portion 120 can comprise a plurality of angular sections at varying degrees disposed in multiple planes. The angles and planes can be selected to optimize access to posterior teeth.

Distal section 122 of working portion 120 can comprise at least one mounting feature 128 onto which a detachable blade 130 can be attached. Mounting feature 128 can be formed by any suitable method and can be integral with working portion 120 or affixed thereto. For example, mounting feature 128 can comprise a keyed groove, such as for example a keyed groove that can be referred to as a “tang”. As shown in the example embodiment of FIG. 2, mounting feature 128 is formed as a keyed groove 152, and detachable blade 130 comprises a corresponding slot 154 configured to slide over keyed groove 152 and lock into place.

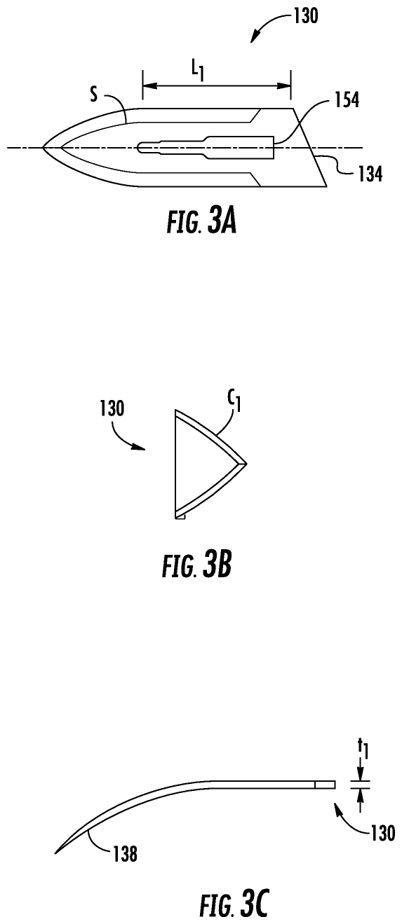

Detachable blade 130 can be formed, configured or shaped in a variety of different ways depending on the intended application. In some aspects, detachable blade 130 can be curved in one direction or in a plurality of directions. For example, detachable blade 130 can be formed substantially in a flat plane, or it can comprise an out-of-plane curvature or portion. Detachable blade 130 can also comprise an in-plane curvature or portion along the sharpened edge toward the terminal point, either curving for example downwardly to form a symmetric blade, or upwardly to form a hook shape. In the example embodiment shown in FIG. 2, detachable blade 130 is substantially symmetric, with a downward curvature on two sides and extending approximately toward the midline of slot 154. Detachable blade 130 also comprises an out-of-plane curvature (not visible in FIG. 2, see, for example, FIGS. 3B, 3C).

FIGS. 3A-3C illustrate an embodiment of detachable blade 130 that has an out-of-plane curvature or portion. Detachable blade 130 has a planar portion which extends along a single plane a distance L₁ from the base, or proximal, blade end 134 of detachable blade 130. Detachable blade 130 can be sharpened to a cutting surface S on any portion of a working edge of the blade, including along curvature 138 (see, FIG. 3C). At the distal blade end 136, detachable blade 130 curves away from the plane of the planar portion and extends upward along an optional curvature C₁, illustrated for example in FIG. 3B. Curvature C₁ can be selected based on the geometry of the area of the tooth to be worked on or restored. Detachable blade 130 can curve in an out-of-plane curvature 138, as illustrated for example in FIG. 3C. Detachable blade 130 can have a thickness ti to provide sufficient stiffness to resist bending.

Detachable blade 130 can additionally be formed so as to be mounted in either a “concave” or “convex” fashion. When detachable blade 130 is mounted to dental carving tool 100 so that it curves toward proximal end 112 of gripping portion 110, this can be referred to as “concave”. The term “concave” describes the curvature of the blade relative to gripping portion 110 and not necessarily relative to the mounting surface or the sharpened edge. FIG. 3A is a side elevation view of detachable blade 130. When mounted on dental carving tool 100, curvature 138 can in one use aspect curve in a direction toward or at least generally toward the practitioner as the tool is held in a standard usage position. Likewise, when detachable blade 130 is mounted to dental carving tool 100 so that it curves away from proximal end 112 of gripping portion 110, this can be referred to as “convex”. The term “convex” also describes the curvature of the blade relative to gripping portion 110 and not necessarily relative to the mounting surface or the sharpened edge.

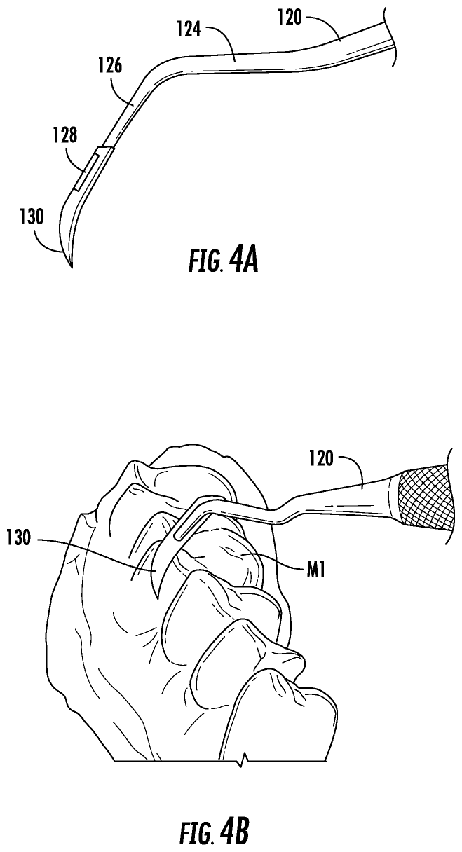

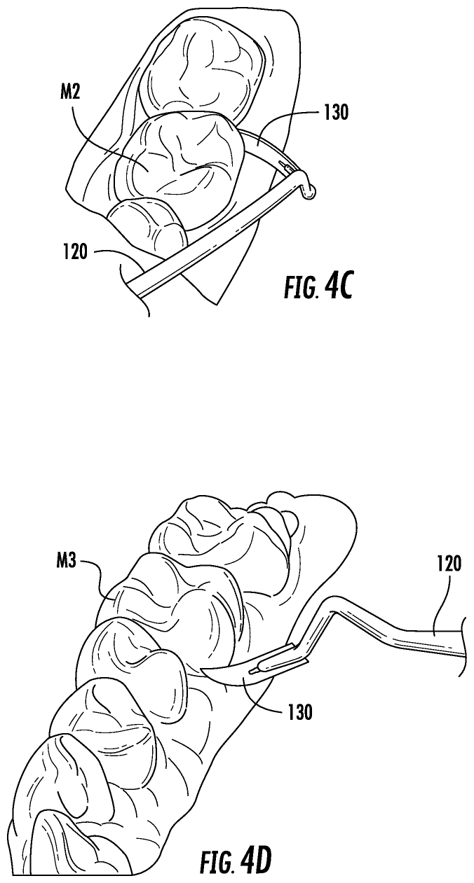

Referring to FIGS. 4A-4D, usage examples of dental carving tool 100 and detachable blade 130 are shown. In FIG. 4A, working portion 120 is shown with detachable blade 130 mounted in a concave manner. For example, dental carving tool 100 is configured such that, when first and second sections 124, 126 are in a vertical orientation, mounting feature 128 curves to the left of dental carving tool 100 and detachable blade 130 curves toward or at least generally toward the user. This allows dental carving tool 100 to be particularly useful for sculpting a distal, lingual, or facial side of a posterior tooth, such as for example a molar. FIG. 4B is an example illustration of this and depicts dental carving tool 100 engaged with a curved facial surface of a molar M1. FIG. 4C depicts dental carving tool 100 engaged with a distal surface of molar M2. In FIG. 4D, working portion 120 is shown with detachable blade 130 mounted in a convex manner. In this case, detachable blade 130 curves at least generally away from the user. In the example illustration of FIG. 4D, dental carving tool 100 is engaged with a mesial surface of a molar M3. The convex orientation of detachable blade 130 can assist in sculpting, for example, a mesial, lingual, or facial surface of a posterior tooth, such as for example a molar.

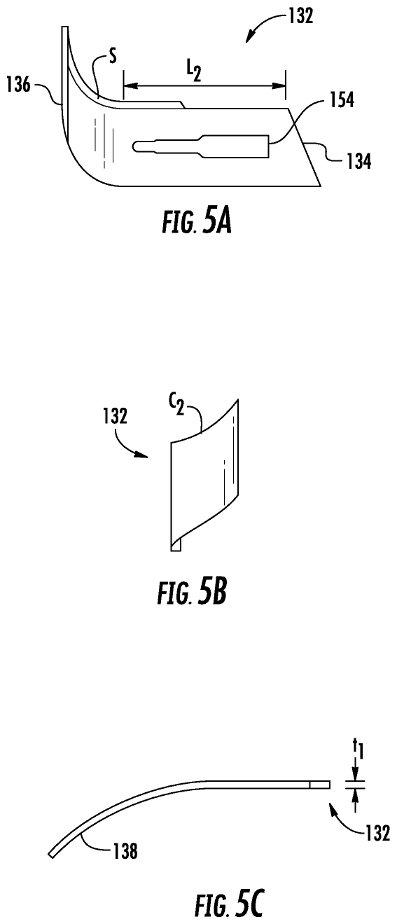

FIGS. 5A-5C illustrate another embodiment of a detachable blade, an upwardly-curving blade generally designated 132. Convex blade 132 curves in both an in-plane and out-of-plane curvature. Upwardly-curving blade 132 can be formed such that it curves in a direction either toward or away from proximal end 112 of gripping portion 110 when attached to dental carving tool 100.

FIG. 5A is a side elevation view of an example embodiment of upwardly-curving blade 132. Upwardly-curving blade 132 has a planar portion which extends along a single plane a distance L₂ from the base, or proximal, blade end 134 of upwardly-curving blade 132. At the distal blade end 136, upwardly-curving blade 132 curves upward along an optional curvature C₂, illustrated for example in FIG. 5B. Curvature C₂ can be selected based on the geometry of the area of the tooth to be restored, or it can be a conventional curvature. Convex blade 132 can also curve in an out-of-plane curvature 138, as illustrated for example in FIG. 5C. Additionally, convex blade 132 can have a thickness t₂ to provide sufficient stiffness to resist bending.

It is to be understood that upwardly-curving blade 132 can be formed as shown in FIGS. 5A-5C, or it can be a mirror image thereof. Thus, when mounted on dental carving tool 100, curvature 138 can in one use aspect curve toward or at least generally toward the user (i.e., in a concave manner) as the tool is held in a standard usage position. In a mirror image configuration, upwardly curving blade 132 can curve generally away from the user (i.e., in a convex manner) as the tool is held in a standard usage position.

In some embodiments, a dental carving tool 100 can be equipped with a working portion 120 on each end of the longitudinal axis. The working portions can be arranged, for example, such that one end of grip portion 110 has a concave blade 132, and the opposite end has a convex blade 134, thus allowing the practitioner to access all areas of a tooth with a single tool.

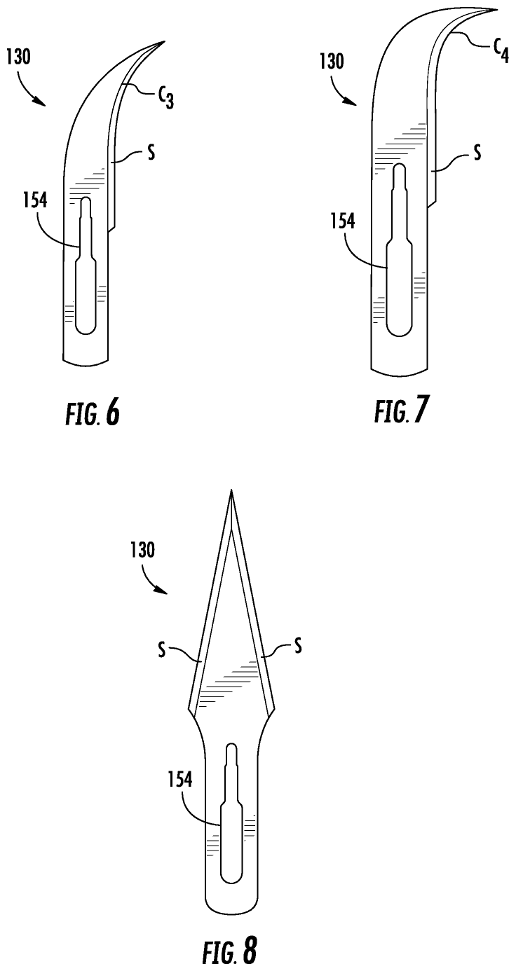

In other embodiments, detachable blade 130 can be formed in any suitable shape for dental restoration. Many conventional blade shapes are available and envisioned herein as some example shapes are illustrated in FIGS. 6-8. In these embodiments, detachable blade generally designated 130 can comprise an elongated, attachment portion that can be substantially flat (i.e., residing in a single plane). Detachable blade 130 can have a sharpened edge that can comprise either flat or curved sections, or a combination of each. Each of FIGS. 6-8 illustrate an example mounting portion, slot 154.

FIG. 6 depicts an example flat blade with a curved portion C₃ having a relatively large radius of curvature. Curved portion C₃ extends tangent to a linear region of the blade. At least some of curved portion C₃ and optionally part of the linear region can comprise a sharpened surface S.

In another example of a detachable blade 130, FIG. 7 depicts a flat blade with a comparatively shorter region of curvature C₄, having a sharpened region S, where curvature C₄ is not tangent with a linear or mounting region of the blade. The amount of curvature can be selected based on the application; for example, a larger radius of curvature can offer better interproximal adaptation.

FIG. 8 illustrates another variant of detachable blade 130. In this embodiment, detachable blade 130 has a lance-shaped tip, which is substantially symmetric and has two sharpened edges S. The cutting edges can be either substantially straight or slightly curving. In this and other embodiments, the sharpened surface S can be disposed on one face, or on both faces of detachable blade 130.

It is to be noted that the geometry of the detachable blade is not limited to the embodiments described herein but can also include combinations of features that suggest themselves to those of ordinary skill in the art.

While several exemplary embodiments of the subject matter are disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s).

Various combinations and sub-combinations of the structures and features described herein are contemplated and will be apparent to a skilled person having knowledge of this disclosure. Any of the various features and elements as disclosed herein can be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

What is claimed is:

1. A dental carving tool comprising:
an elongated grip portion with a longitudinal axis, the grip portion comprising a proximal end and a distal end;
at least one working portion extending from the distal end of the grip portion;
a detachable blade for removably mounting on the working portion; and
the working portion comprising at least a distal section at an angle offset from the longitudinal axis, the distal section comprising a mounting portion for a detachable blade,
wherein the detachable blade is configured to scrape or carve against a tooth or a dental restoration. 15

2. The dental carving tool according to claim 1, wherein the distal section is offset from the longitudinal axis by an angle in a range of approximately 35°-90°.

3. The dental carving tool according to claim 1, wherein the detachable blade comprises a non-planar, curved distal portion.

4. The dental carving tool according to claim 3, wherein the detachable blade comprises a non-planar, curved distal portion, which curves away from a longitudinal axis of the distal section.

5. The dental carving tool according to claim 1, wherein the distal section is offset from the longitudinal axis by an angle of approximately 75° or more.

6. The dental carving tool according to claim 1, wherein the working portion comprises one or more intermediate section between the grip portion and the distal section.

7. The dental carving tool according to claim 1, further comprising a second working portion at the second end of the grip portion.

8. The dental carving tool according to claim 7, wherein the two working portions are configured as mirror images of one another.

9. The dental carving tool according to claim 1, wherein the detachable blade is substantially planar.

10. The dental carving tool according to claim 1, wherein the detachable blade comprises an upwardly curving edge over at least a portion of the detachable blade.

11. The dental carving tool according to claim 1, wherein the detachable blade comprises a lance-shaped blade with two sharpened edges, which are either flat or curved.

12. The dental carving tool according to claim 1, wherein the detachable blade is sharpened on both faces.

13. The dental carving tool according to claim 1, wherein the detachable blade is sharpened on only one face.

14. The dental carving tool according to claim 1, wherein the working portion is removably attached to the grip portion.

15. A dental carving tool comprising:
an elongated grip portion with a longitudinal axis, the grip portion comprising a proximal end and a distal end;
at least one working portion extending from the distal end of the grip portion;
a detachable blade for removably mounting on the working portion; and
the working portion comprising at least a distal section at an angle offset from the longitudinal axis, the distal section comprising a mounting portion for a detachable blade,
wherein the detachable blade is configured to scrape or carve against a tooth or a dental restoration,
wherein the distal section is offset from the longitudinal axis by an angle in a range of approximately 35°-90 °, and
wherein the detachable blade comprises a non-planar, curved distal portion, which curves in a direction either toward or away from the proximal end of the grip portion when the detachable blade is mounted on the working portion.

16. A method for treating a posterior tooth for a dental restoration, comprising:
providing a dental carving tool, the dental carving tool comprising:
an elongated grip portion with a longitudinal axis, the grip portion comprising a proximal end and a distal end;
at least one working portion extending from the distal end of the grip portion;
a detachable blade for removably mounting on the working portion; and
the working portion comprising at least a distal section at an angle offset from the longitudinal axis, the distal section comprising a mounting portion for a detachable blade,
wherein the detachable blade is configured to scrape or carve against a tooth or a dental restoration, and
applying the dental carving tool to the posterior tooth.
